(19) United States
(12) Patent Application Publication
(10) Pub. No.: US 2020/0150363 A1
(43) Pub. Date: May 14, 2020

(54) CONDUCTIVE MULTI-FIBER/PORT HERMETIC CAPSULE AND METHOD

(71) Applicant: Lightwave Logic Inc., Longmont, CO (US)

(72) Inventor: Michael Lebby, San Francisco, CA (US)

(73) Assignee: Lightwave Logic Inc., Longmont, CO (US)

(21) Appl. No.: 16/186,257

(22) Filed: Nov. 9, 2018

(51) Int. Cl. G02B 6/42

(52) U.S. Cl. CPC G02B 6/4253; G02B 6/4207; G02B 6/4277

(57) ABSTRACT

A conductive hermetically sealed monolithic photonic integrated circuit with optical components and multiple optical and electrical inputs/outputs includes a semiconductor/metal base having sensitive components with multiple optical and electrical inputs, multiple optical and electrical outputs, and/or multiple optical and electrical inputs and outputs. An electrically conductive basic lid includes at least two of metal, dielectric and semiconductor materials combined to form an electrically conductive protective circuit. The conductive basic lid is sealed to the semiconductor/metal base by metallization so as to form a chamber including the sensitive components and hermetically sealing the chamber and the sensitive component from the ambient in a basic hermetic capsule and the electrically conductive protective circuit is formed and connected to protect the sensitive components from external electrical interference.

### FIELD OF THE INVENTION

This invention relates to multiple optical fibers optically coupled to multiple input/output ports in a conductive capsule.

### BACKGROUND OF THE INVENTION

Polymer modulators driven by semiconductor lasers are a popular apparatus for modulating a light beam. In a copending U.S. patent application entitled “Polymer Modulator and Laser Integrated on a Common Platform and Method”, filed Aug. 31, 2017, with application Ser. No. 15/692,080, and incorporated herein by reference, the modulator and laser are integrated on a common platform, such as an InP chip or substrate. Further, in a U.S. copending patent application entitled “Hermetic Capsule and Method”, filed Jan. 26, 2018, with application Ser. No. 15/881,718, and incorporated herein by reference, the integrated platform is hermetically sealed with a semiconductor/metal base and a semiconductor/metal lid sealed to the base. In many applications it is highly desirable to provide multiple input/output ports and multiple optical fibers, one each, optically coupled to each input/output port as described in a copending U.S. Patent Application entitled “Multi-Fiber/Port Capsule and Method”, filed May 31, 2018, with application Ser. No. 15/994,966, and incorporated herein by reference.

It has been found that by including electrically conductive layers in the encapsulating covers disclosed in at least some of the above described copending patent applications many advantages can be achieved. For example, conductive encapsulating covers help to protect optical devices and the included polymers from the environment. Also, conductive encapsulating covers suppress electrical cross-talk and rf interference as well as assisting in high performance operation (100 GBaud or 100 Gbps and bandwidths greater than 50 GHz).

It would be highly advantageous, therefore, to provide the foregoing in conductive multi-fiber/port hermetic capsules.

Accordingly, it is an object of the present invention to provide a new and improved conductive hermetic capsule sealing electrical and/or optical components on a common platform and including conductively protected multiple optical and electrical input/output ports with multiple optical fibers optically coupled to the multiple optical ports.

It is another object of the present invention to provide a new and improved conductive hermetic capsule sealing one or more conductively protected semiconductor lasers and polymer modulators integrated on a common platform, with multiple input/output ports.

It is another object of the present invention to provide a new and improved conductive hermetic capsule with multiple input/output ports coupled to multiple optical fibers in a wafer scale solution that is cost effective.

### SUMMARY OF THE INVENTION

A conductive hermetically sealed monolithic photonic integrated circuit with optical components and multiple optical and electrical inputs/outputs includes a semiconductor/metal base having sensitive semiconductor/polymer electrical and optical components with multiple optical and electrical inputs, multiple optical and electrical outputs, and/or multiple optical and electrical inputs and outputs. An electrically conductive basic lid includes at least two of metal, dielectric and semiconductor materials combined to form an electrically conductive protective circuit. The conductive basic lid is sealed to the semiconductor/metal base by metallization so as to form a chamber including the sensitive components and hermetically sealing the chamber and the sensitive component from the ambient in a basic hermetic capsule and the electrically conductive protective circuit is formed and connected to protect the sensitive components from external electrical interference.

To further achieve the desired objects and advantages of the present invention a specific embodiment of a conductive hermetically sealed monolithic photonic integrated circuit (PIC) including optical components and multiple optical and electrical inputs/outputs is provided. The specific embodiment includes a semiconductor/metal base having sensitive semiconductor/polymer electrical and optical components with multiple optical and electrical inputs, multiple optical and electrical outputs, and/or multiple optical and electrical inputs and outputs, an embedded lid and an electrically conductive basic lid including at least two of metal, dielectric and semiconductor materials combined to form an electrically conductive protective circuit. The embedded lid is sealed to the semiconductor/metal base by metallization so as to form an embedded chamber including one or more of the sensitive semiconductor/polymer electrical and optical components and hermetically sealing the embedded chamber and the one or more sensitive components from the ambient in an embedded hermetic capsule and protecting the one or more sensitive semiconductor/polymer electrical and optical components from external ambient. The electrically conductive basic lid is sealed to the semiconductor/metal base by metallization so as to form a hermetically sealed basic chamber, the basic chamber surrounding and hermetically sealing the sensitive semiconductor/polymer electrical and optical components including the embedded hermetic capsule in a hermetically sealed basic hermetic capsule. The electrically conductive protective circuit is formed and connected to protect the sensitive semiconductor/polymer electrical and optical components from external electrical interference and the basic hermetic capsule including multiple optical pathways coupling multiple optical fibers to the optical components sealed within the chamber.

To further achieve the desired objects and advantages of the present invention a specific embodiment of a method of fabricating a conductive hermetically sealed monolithic photonic integrated circuit (PIC) including optical components and multiple optical and electrical inputs/outputs is provided. The method includes the steps of providing a first semiconductor/metal wafer and fabricating sensitive semiconductor/polymer electrical and optical components in the first semiconductor/metal wafer defining a semiconductor/metal base the method further includes the steps of fabricating a semiconductor/metal embedded lid in a shell-like form providing edges defining a volume space within the edges and hermetically sealing the edges of the semiconductor/metal embedded lid to the semiconductor/metal base by metallization so as to form a first chamber including at least one of the sensitive semiconductor/polymer electrical and optical components, the embedded lid and base defining an embedded hermetic capsule hermetically sealing the at least one sensitive semiconductor/polymer electrical and optical component from the ambient. The method further includes the steps of fabricating an electrically conductive basic lid including at least two of metal, dielectric and semiconductor materials and combining the at least two of metal, dielectric and semiconductor materials to form an electrically conductive protective circuit and hermetically sealing the edges of the electrically conductive basic lid to the semiconductor/metal base by metallization so as to form a hermetically sealed basic chamber, the basic chamber surrounding and hermetically sealing the sensitive semiconductor/polymer electrical and optical components including the embedded hermetic capsule in a hermetically sealed basic hermetic capsule. The electrically conductive protective circuit is formed and connected to protect the sensitive semiconductor/polymer electrical and optical components from external electrical interference and the basic hermetic capsule including multiple optical pathways couples multiple optical fibers to the optical components sealed within the chamber.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a perspective view of embedded hermetic capsules within a basic hermetic capsule (all in an open configuration to illustrate internal components) with integrated laser/polymer modulators and multi-fibers/ports;

FIG. 2 is a perspective view of another example of embedded hermetic capsules within a basic hermetic capsule (all in an open configuration to illustrate internal components) with integrated laser/polymer modulators and multi-fibers/ports;

FIG. 3 is a perspective view of the lid of either an embedded hermetic capsule or a basic hermetic capsule (depending upon the size) of FIGS. 1 and 2;

FIG. 4 illustrates a preferred process for fabricating the lid of FIG. 3;

FIGS. 5A through 5C illustrate several examples of electrically conductive hermetic capsule lids in accordance with the present invention;

FIGS. 6A through 6C illustrate metallization for hermetic sealing of the electrically conductive hermetic capsule lids of FIGS. 5A through 5C;

FIGS. 7A through 7D illustrate several examples of electrically conductive layers that can be incorporated into any of the electrically conductive hermetic capsule lids illustrated FIGS. 5A through 5c, or other lids that might be conceived;

FIG. 8 illustrates an example of an electric connection to an electrically conductive hermetic capsule lid, in accordance with the present invention;

FIGS. 9A through 9M illustrate steps in the process of fabricating one example of the embedded hermetic capsule{s} within a basic hermetic capsule, in accordance with the present invention;

FIG. 10 illustrates one example of an electrically conductive basic hermetic capsule lid incorporated in the hermetic capsule of FIG. 9M;

FIG. 11 illustrates examples of modifications of the hermetic capsule of FIG. 10;

FIGS. 12A and 12B illustrate steps in the fabrication of another example of a hermetic capsule with multi-fibers/ports and embedded hermetic capsule{s} within a basic hermetic capsule, in accordance with the present invention;

FIG. 13 is a top plan view of the hermetic capsule of FIG. 12B further illustrating the external electrical connections, in accordance with the present invention; and

FIG. 14 is a top plan view illustrating another embodiment of the hermetic capsule of FIG. 12B further illustrating the external electrical connections, in accordance with the present invention.

### DETAILED DESCRIPTION OF THE DRAWINGS

A primary object of the present invention is to provide electrically conductive hermetically sealed capsules for sensitive laser and polymer modulators integrated on a common platform with multiple input/output ports and multiple optical fibers optically coupled to the ports. In conjunction with the present disclosure hermetic (e.g. hermetically sealed) is defined as “air tight and sealed against gas or vapor or moisture that would affect device performance”. An example of such components is the monolithic photonic integrated circuits described in copending patent application entitled “POLYMER MODULATOR AND LASER INTEGRATED ON A COMMON PLATFORM AND METHOD”, filed Aug. 31, 2017, Ser. No. 15/692,080, and incorporated herein by reference. Further, examples of hermetically sealed capsules are described in a copending application entitled “Hermetic Capsule and Method”, filed 26, 2018, with application Ser. No. 15/881,718, and incorporated herein by reference. In the specific example set forth below, the common platform is single crystal InP, because lasers are naturally fabricated from InP and are already monolithic (part of the same material). It will be understood however, that the common platform could be InP, GaAs, GaN, sapphire, silicon or any combinations thereof. Also, while the laser/lasers described herein are generally InP, it will be understood that the lasers could be GaAs, GaN, etc. As will also be understood from the following description, the modulators in this specific example are polymer based. Further, the optical connection between the laser and modulator, in this specific example, is either polymer waveguides, or semiconductor material waveguides matching the laser (i.e. InP waveguide with InP laser). Also, the optical connecting waveguides could be dielectric based, such as silicon dioxide, silicon nitride, etc.)

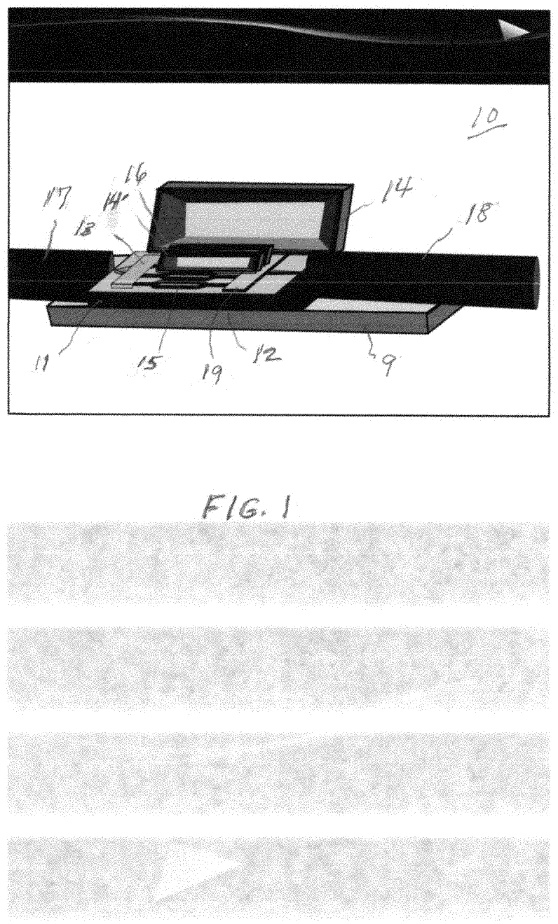

Turning to FIG. 1, a basic hermetic capsule 10 is illustrated including a base (wafer, etc.) 12 and a basic lid 14 with one or more, smaller lids 14′ which are constructed to hermetically seal components of integrated laser/polymer modulator 16. For purposes of this disclosure, lids 14′ are defined as “embedded lids” and the combination of embedded lids 14′ and the hermetically sealed component or components is defined as an “embedded hermetic capsule”. Embedded lids 14′ and basic lid 14 are illustrated in an open configuration to show integrated laser/polymer modulator 16 and the coupling of optical fibers 17 and 18. In this example, optical fiber 17 is optically coupled through an optical input to an integrated circuit 13 which may include, for example, spot size converters or other optical components. Integrated circuit 13 is in turn optically coupled through waveguides to a plurality of Mach-Zehnder modulators 15. The outputs of Mach-Zehnder modulators 15 are coupled to a Mux/demux circuit which is coupled through a spot size converter (SSC) output, designated in combination 19, to optical fiber 18. Thus, one or more light beams are introduced to the plurality of Mach-Zehnder modulators 15 which modulate the light beams and send the modulated light beams out through mux/demux circuit 19 to output optical fiber 18.

In this disclosure, the “base” is defined as the structure carrying all of the electro-optic components, and is generally illustrated and discussed as a single or common platform. However, it will be understood that the base could be fabricated in a semiconductor/metal wafer, designated 11 in FIG. 1, which could in turn be mounted on a capsule platform, designated 9, in FIG. 1. Capsule platform 9 could be fabricated from silicon, GaAs, metal, plastic, or any other suitable organic or inorganic material which would serve to hold the semiconductor/metal wafer and optical fibers 17 and 18 in a fixed relationship. In applications where the base is mounted on a capsule platform, as illustrated in FIG. 1, some of the etching steps defining the right-hand edge of the base, described below, may not be needed.

Turning to FIG. 2, an example of another hermetically sealed capsule 110 with multi-fibers/optics is illustrated. Capsule 110 includes a base 112 with a plurality of lasers 113 coupled, one each, to a plurality of modulators 115 (in this example Mach-Zehnder modulators) defining a plurality of monolithic photonic integrated circuits. Base 112 further includes one or more (in this example two) embedded hermetic capsules (i.e. lids 114′ in the closed or sealed orientation} each hermetically sealing a single monolithic photonic integrated circuit or integrated laser/polymer modulator 116. A basic hermetic capsule 114 with multiple optical output ports, and multiple optical fibers 117 and 118 optically coupled to the optical ports is illustrated, in accordance with the present invention. Basic hermetic capsule 110 is illustrated including base (wafer, etc.) 112 and a basic lid 114 and the one or more, smaller embedded lids 114′. For purposes of this disclosure, lids 114′ are defined as “embedded lids” and the combination of embedded lids 114′ and the hermetically sealed component or components is defined as an “embedded hermetic capsule”. Embedded lids 114′ and basic lid 114 are illustrated in an open configuration to show integrated laser/polymer modulators 116 and the coupling of optical fibers 117 and 118. In this example, optical fiber 117 is optically coupled to one output of an output circuit 119, such as a mux/demux, SSC or the like. Output circuit 119 is in turn optically coupled through waveguides to the plurality of Mach-Zehnder modulators 115 in integrated laser/polymer modulator 116. Optical fiber 18 is optically coupled to another optical output of output circuit 119 which is in turn optically coupled through waveguides to the plurality of Mach-Zehnder modulators 115 in integrated laser/polymer modulator 116. Thus, lasers 113 introduce one or more light beams to the plurality of Mach-Zehnder modulators which modulate the light beams and send the modulated light beams out through mux/demux circuit 119 to output optical fibers 117 and 118.

In this disclosure FIGS. 1 and 2 are employed to illustrate some basic concepts of providing multiple input/output ports in hermetically sealed capsules for sensitive laser and polymer modulators integrated on a common platform. Various additional embodiments are illustrated in the above described copending applications and explained for hermetically sealing the capsule and coupled optical fiber in a variety of potential configurations to provide for different applications and/or different components. In all instances, it should be understood that the specific examples of hermetically sealed capsules for sensitive laser and polymer modulators integrated on a common platform with multiple input/output ports and multiple optical fibers disclosed may incorporate or be replaced with some or all of the concepts set forth herein and in the copending applications.

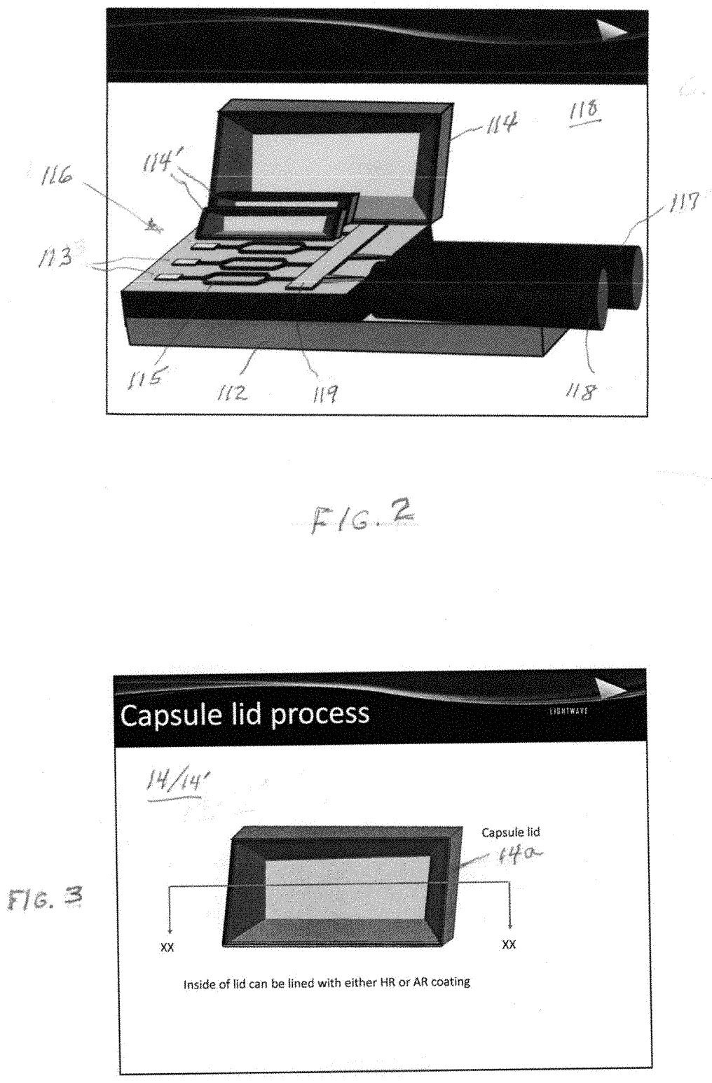

Referring to FIG. 3, lid 14 or lid 14′, depending upon the size, is illustrated individually to better show fabrication steps illustrated in FIG. 4. In the preferred embodiment, lids 14 and 14′ are fabricated from the same material as base 12 and in a shell-like form to define an internal volume surrounded by a peripheral edge 14a. For example, base 12 is fabricated from InP so that the laser can be fabricated monolithically (i.e. on the same wafer), as described in more detail in the above described copending patent application. Further, since base 12 and lids 14 and 14′ are formed of the same material, in the preferred embodiment, the coefficient of temperature expansion (CTE) will be the same. It should be understood, however, that other wafer materials, such as GaAs, GaN, silicon, sapphire, etc., could be used to fabricate base 12 and lids 14 and 14′ and in some cases, depending upon the CTE, base 12 and lids 14 and 14′ might be made of different material, to reduce cost or for other reasons.

Referring additionally to FIG. 4, some steps in a process of fabricating lids 14 and 14′ are illustrated. FIG. 4 illustrates a wafer 20 of the material selected for lids 14 and 14′. In the preferred process, wafer 20 is masked, photolithographed and deep trenches 22 are etched in a two dimensional format. Well-known wet and dry etching techniques can be used. In this fashion an array of two-dimensional trenches 22 are formed across wafer 20. As will be understood by those skilled in the art, each trench 22 defines a lid 14 or 14′ hollowed out (shell-like form) to provide a volume space within the confines of edge 14a. The edges 14a of each trench 22 can be singulated into individual lids 14 or 14′ before attachment to corresponding bases 12. However, in some applications it may be more convenient to align and then simultaneously bond multiple lids 14 or 14′ still connected by the continuous material to corresponding bases 12 (also formed in a matching array on a second wafer). The bonded bases/lids could then be singulated into individual components.

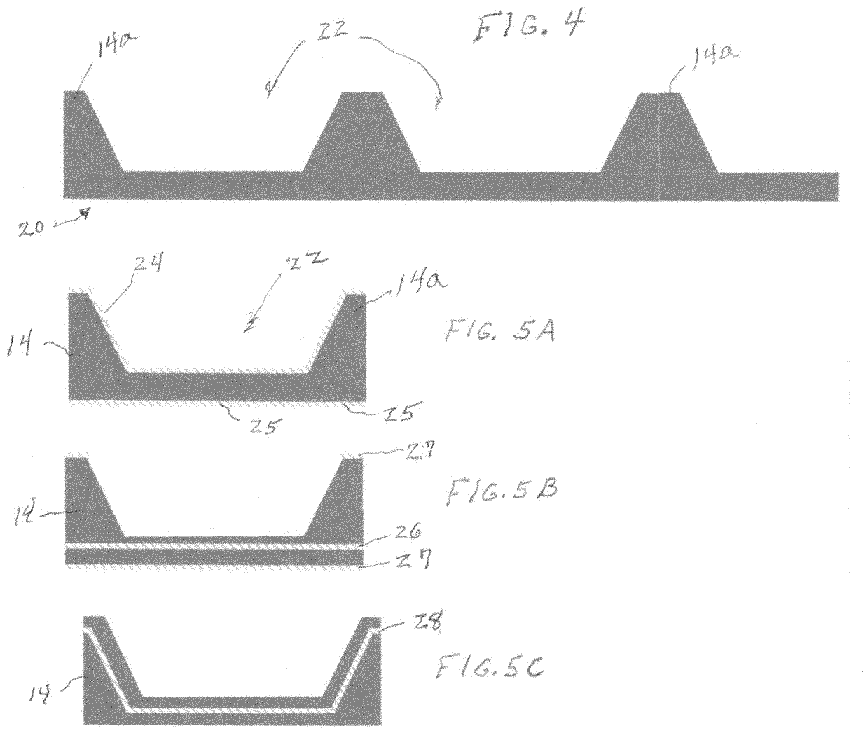

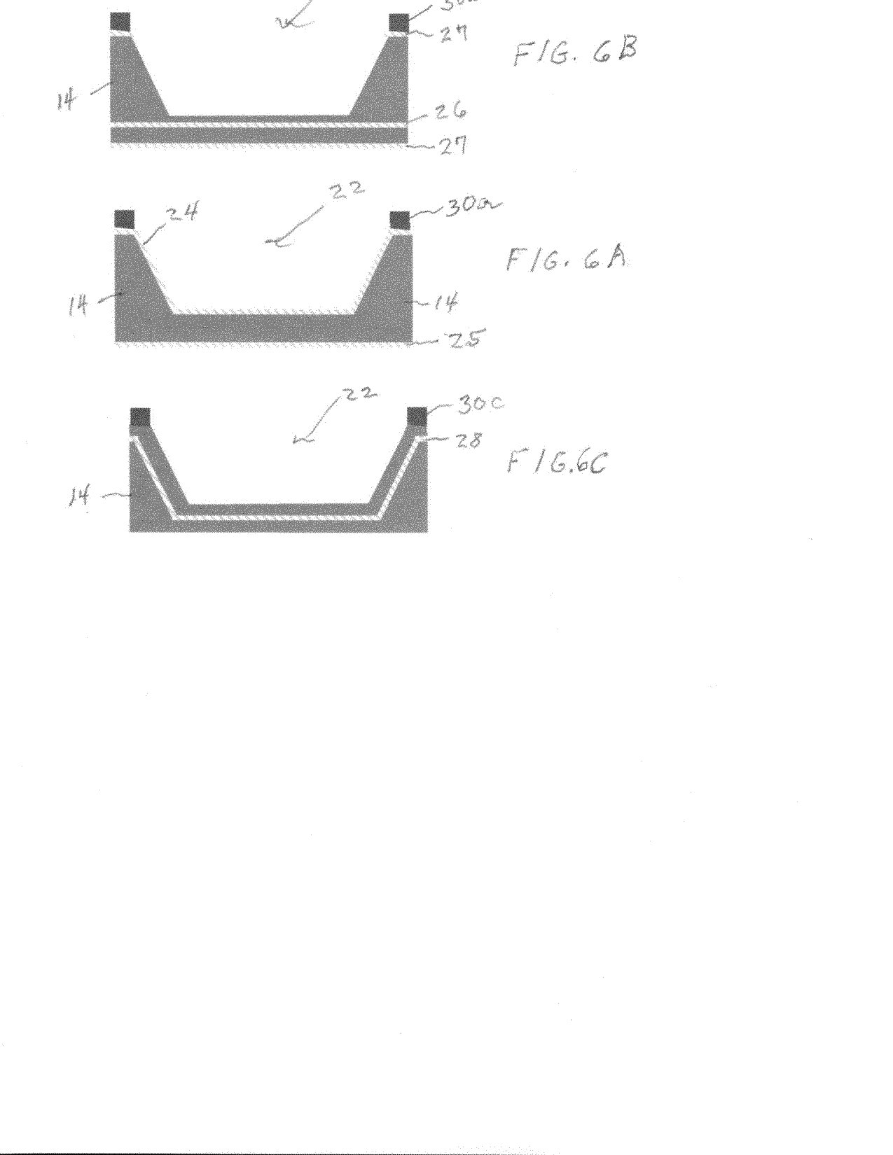

Turning to FIGS. 5A through 5C, several examples of electrically conductive hermetic capsule lids in accordance with the present invention are illustrated. Referring specifically to FIG. 5A, a lid 14 includes a conductive coating 24 over the entire surface of trench 22 and the upper surface of edge 14a. A conductive coating 25 is also applied across the lower (outer when installed) surface. Referring specifically to FIG. 5B, a lid 14 includes a conductive coating 26 embedded midway between the bottom of trench 22 and the lower (outer when installed) surface. A conductive coating 27 is also applied across the lower (outer when installed) surface and to the upper surface of edge 14a. Referring to FIG. 5C, a conductive coating 28 is embedded within the body of a lid 14 so as to extend approximately parallel to the surface of trench 22. Conductive coating 28 also extends parallel to the upper surface of edge 14a to the outer surface of edge 14a to be externally accessible. Here it should be understood that in addition to being electrically conductive a conductive lid may include passive and/or inactive electronic components. For example, the parallel spaced apart conductive coating 26 and 27 of FIG. 5B might serve as a capacitor in addition to providing protection/suppression of electrical interference. It will be understood that co-planar high frequency designs are included and the lids could be designed using co-planar techniques.

In the examples illustrated in FIGS. 5B and 5C, conductive coatings 26 and 28, respectively, could be fabricated by first depositing conductive coating 26 or 28 on a basic portion of the structure and then depositing an additional layer of non-conducting material, the same or different from the basic portion, to form conductive coating 26 or 28 in the illustrated sandwich. Thus, lid 14, whether employed as a basic lid or an embedded lid, can be fabricated by hollowing out trench 22 using etching techniques (either wet or dry), it can be layered between metal and dielectric materials as well as metal, dielectric and semiconductor materials to suppress rf interference, and it can be layered between metal and semiconductor materials to suppress rf interference.

Referring additionally to FIGS. 6A through 6C, metallization for hermetic sealing of the electrically conductive hermetic capsule lids is illustrated. Referring specifically to FIG. 6A, metallization 30a is applied on the upper surface of conductive coating 24 on the upper surface of edge 14a. Thus, after metallization 30a bonds lid 14 to a base to form a hermetically sealed capsule, conductive coating 24 is externally accessible without affecting the hermetic seal. Referring specifically to FIG. 6B, metallization 30b is applied on the upper surface of conductive coating 27 on the upper surface of edge 14a. Thus, after metallization 30b bonds lid 14 to a base to form a hermetically sealed capsule, conductive coatings 26 and 27 are externally accessible without affecting the hermetic seal. Referring specifically to FIG. 6C, metallization 30c is applied on the upper surface of the upper surface of edge 14a. Because conductive coating 28 extends to the outer surface of edge 14a, after metallization 30c bonds lid 14 to a base to form a hermetically sealed capsule, conductive coating 28 is externally accessible without affecting the hermetic seal.

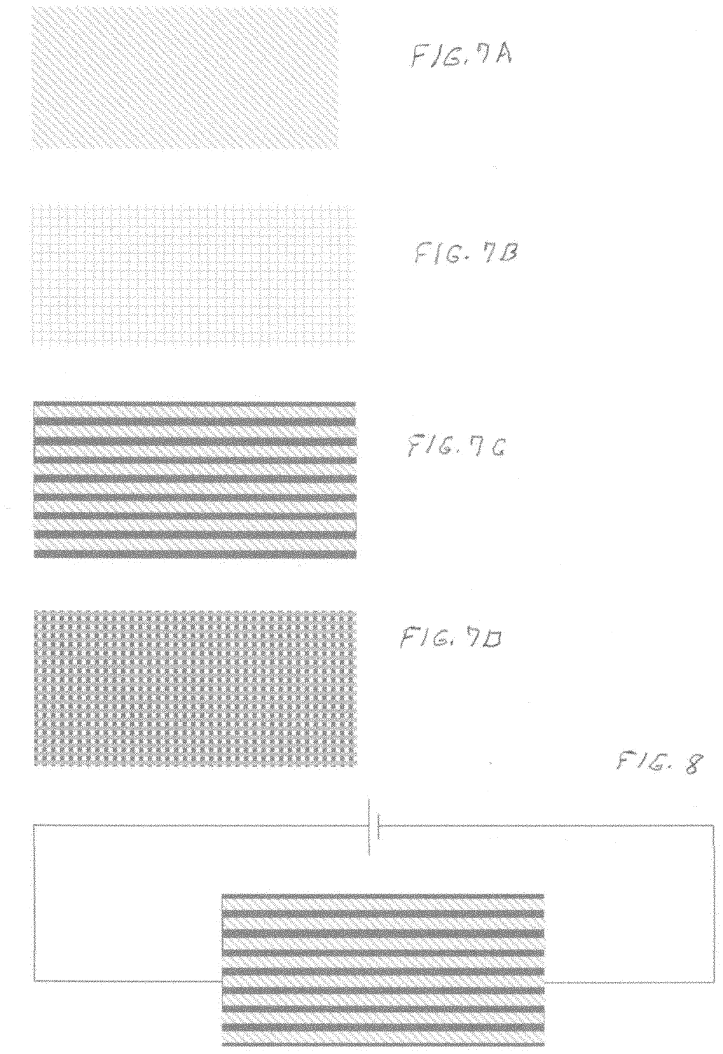

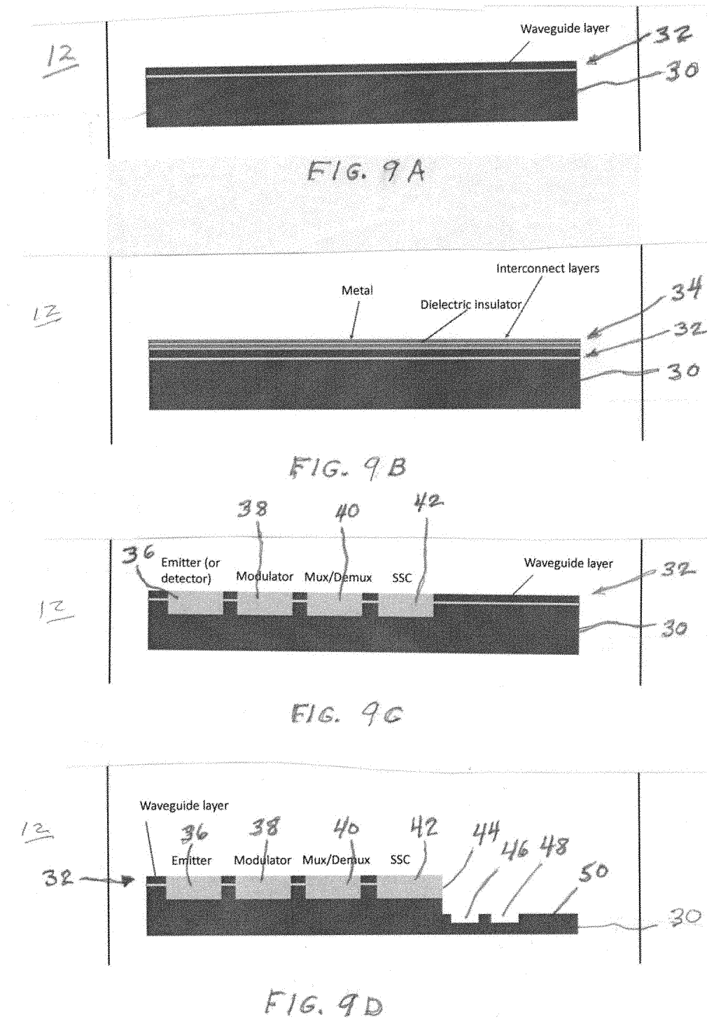

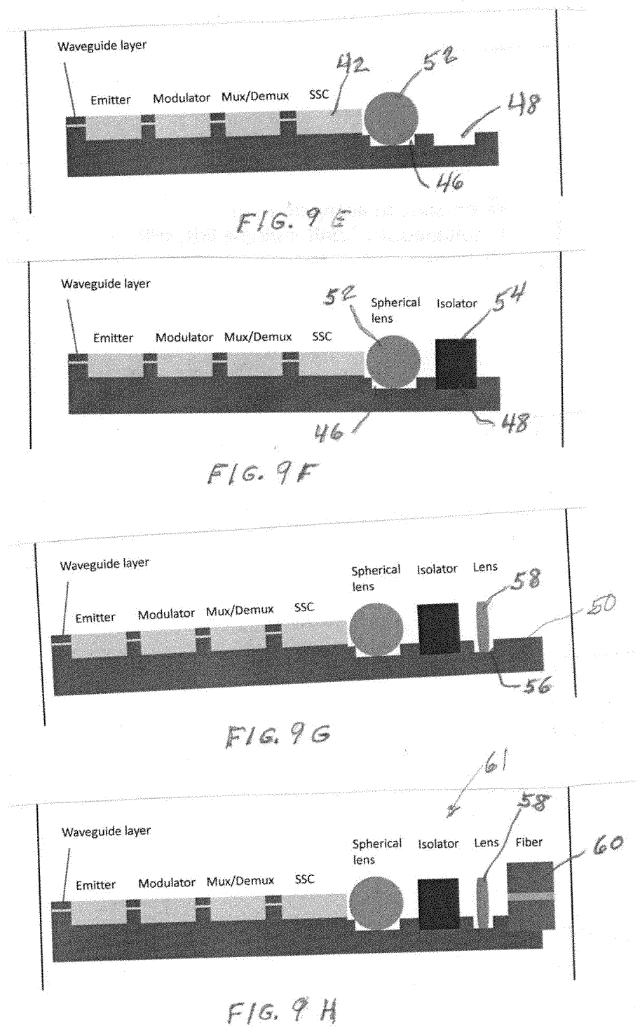

Referring additionally to FIGS. 7A through 7D, examples of electrically conductive layers that can be used in any of conductive layers 24 through 28, described above, or any other lids that might be conceived. It will be understood that conductive layers 24 through 28 (or any other conductive layers devised) can be grid, planar, and different shapes/patterns. Also, conductive layers 24 through 28 can be connected directly to ground, serve as a signal ground, or connected into a Faraday cage concept with electrical bias and electrical field gradients, thereby forming an electrically conductive protective circuit generally as illustrated schematically in FIG. 8.

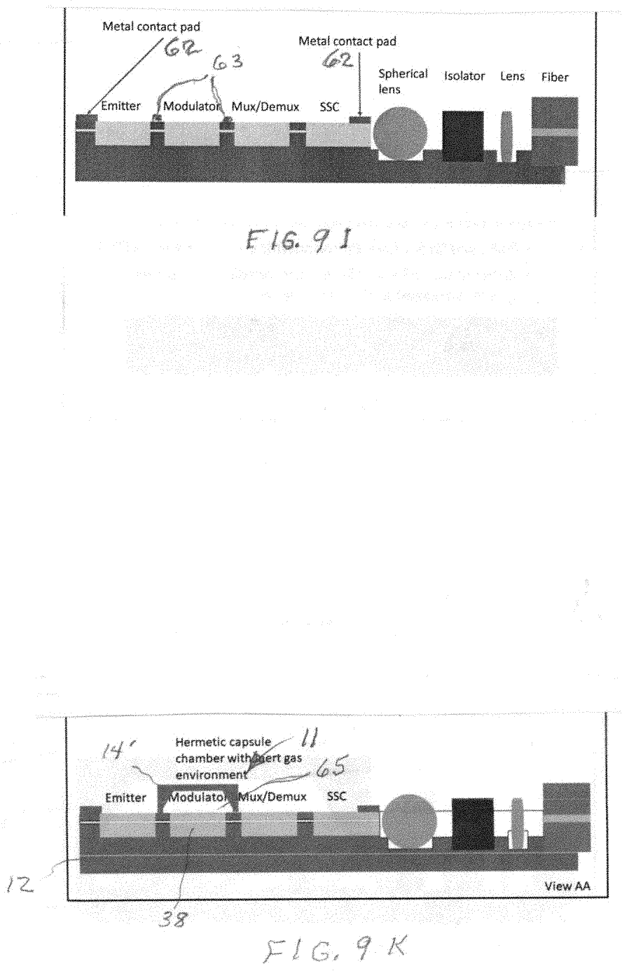

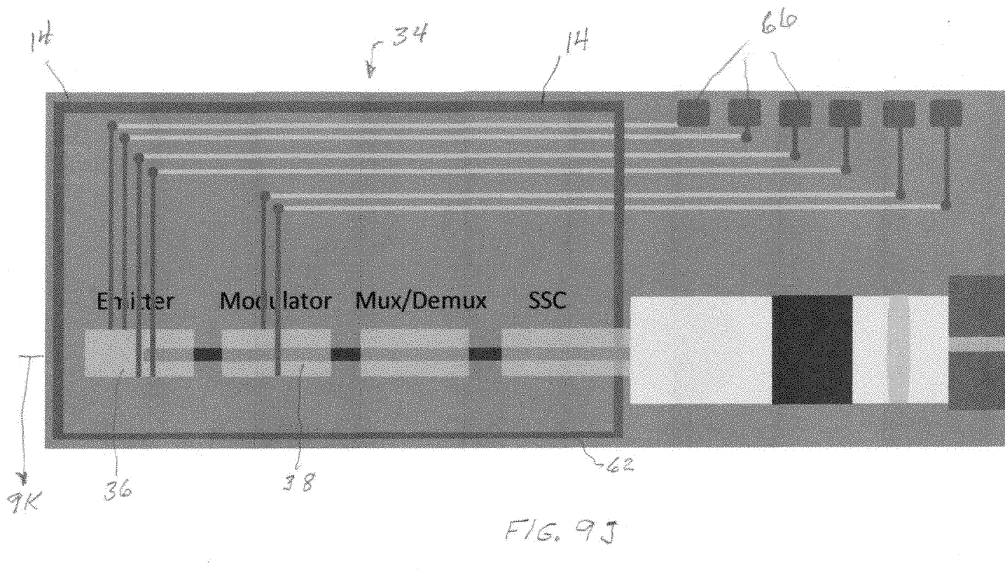

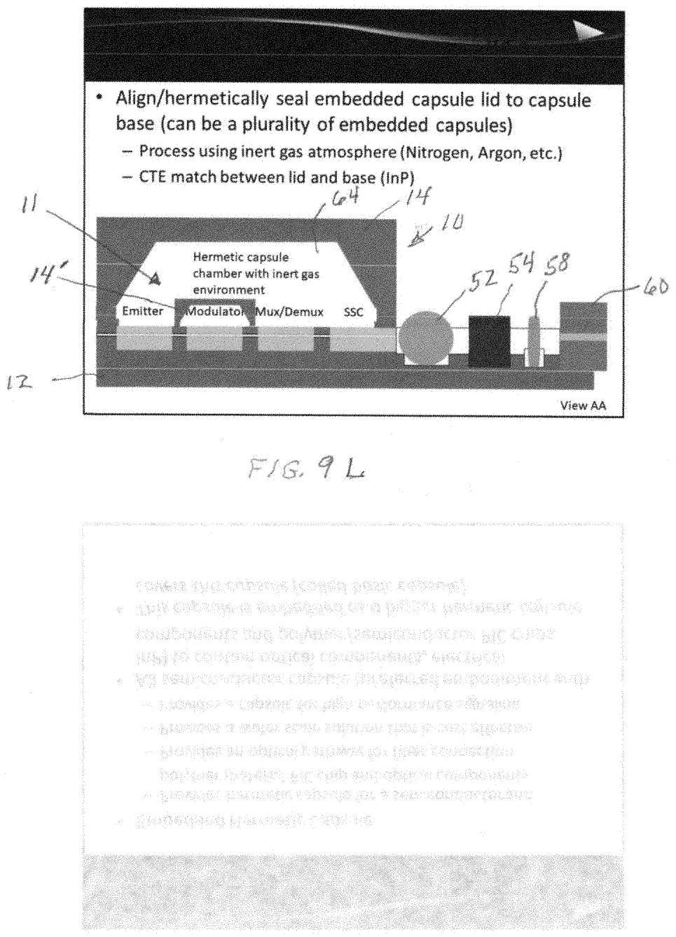

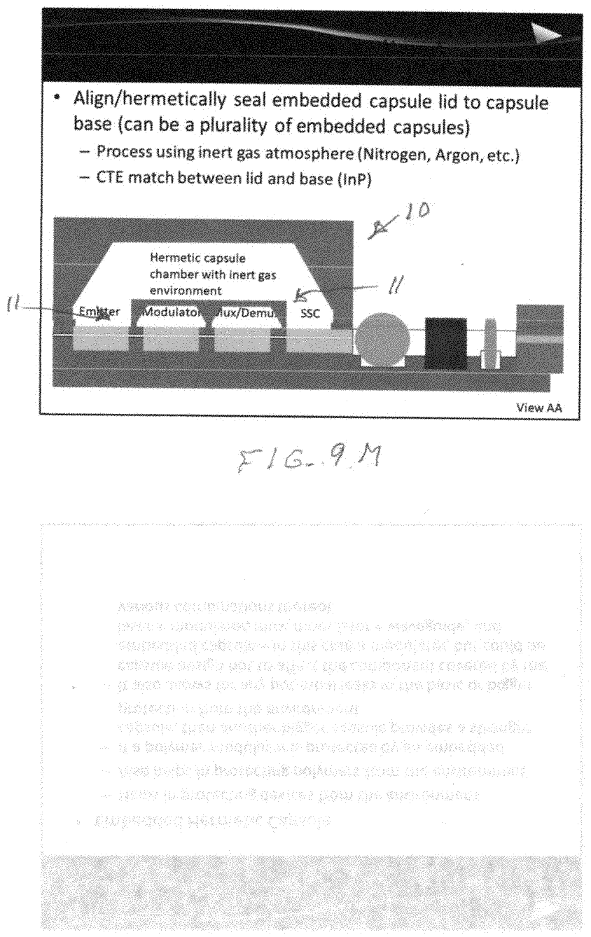

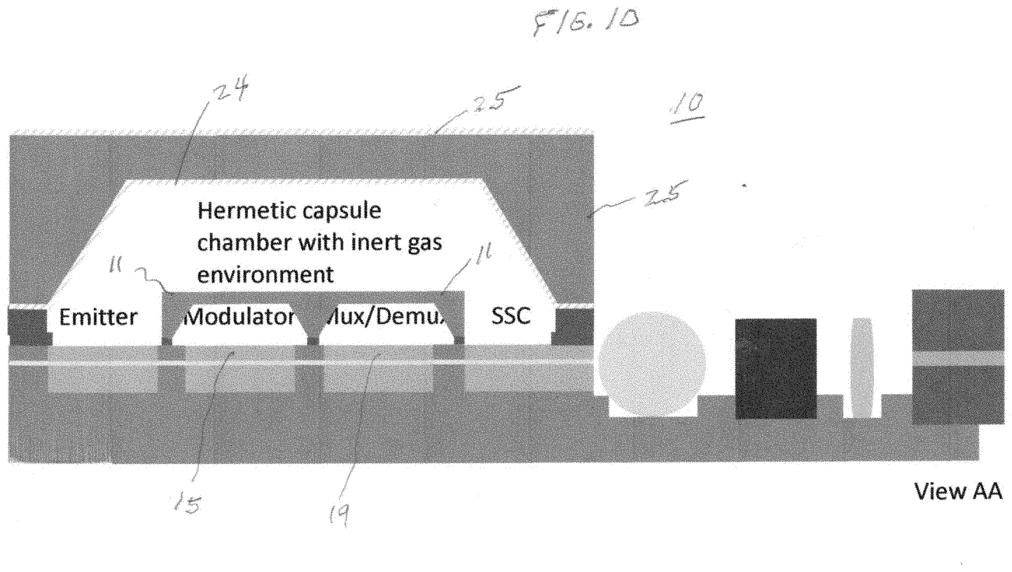

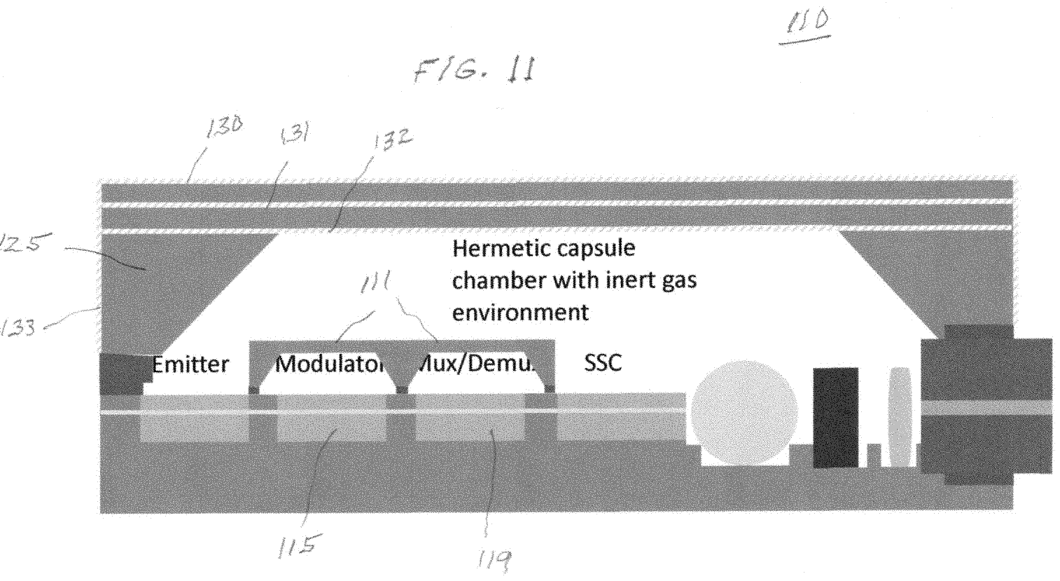

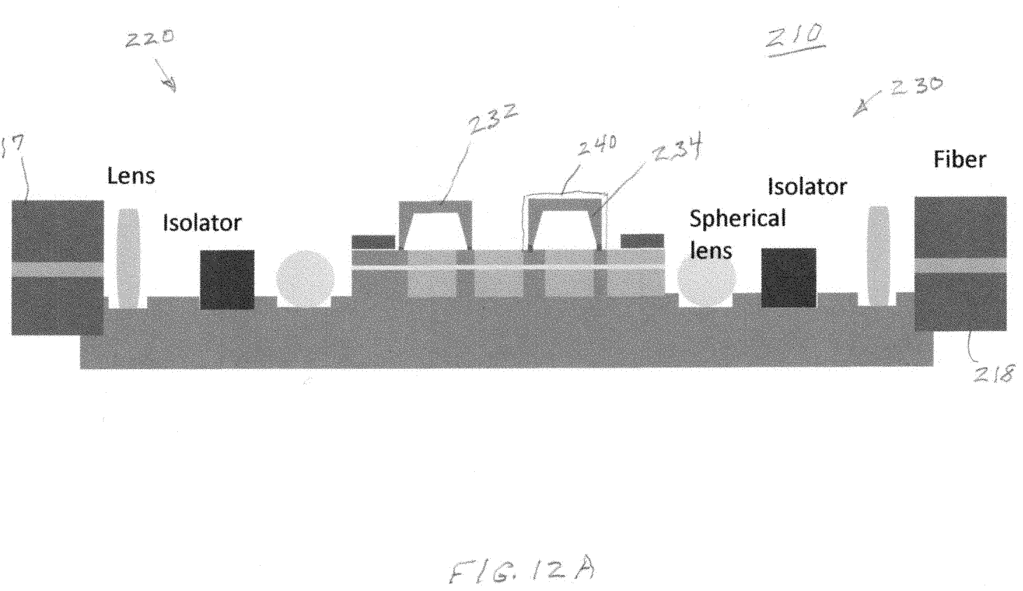

Turning now to FIG. 9A through FIG. OM, steps for fabricating base 12, including integrated laser/polymer modulator 16 and optical fiber 18 optically coupled to integrated laser/polymer modulator 16, are illustrated. In this example a single inlet/outlet is illustrated for convenience of understanding but it will be understood that the same concept can be used to fabricate hermetic capsules with multi-ports/fibers. Also, while a single base 12 is illustrated for convenience of the viewer, it should be understood that an array of bases similar to that illustrated could be formed in a wafer so as to be aligned with the array of lids illustrated in FIG. 4. To this end, FIG. 9A through FIG. 9M, can be considered to illustrate a single one of an array of bases.

Referring specifically to FIG. 9A, a semiconductor wafer 30 is provided. Wafer 30 includes InP in the preferred embodiment because a laser diode can be fabricated monolithically as a source of light for the structure. The wafer can include GaAs, GaN, silicon, etc. In the case of GaAs and GaN, monolithic emitters (lasers or LEDs) can be formed monolithically but in the case of a silicon wafer, InP, GaAS, or GaN would be grown or bonded on the silicon wafer to provide for a monolithic emitter. With further reference to FIG. 9A, semiconductor wafer 30 is modified by the growth of epi layers 32 to define laser/waveguide structures. Some laser/waveguide structures that might be formed include, for example, quantum wells, waveguide cladding layers, highly and lightly doped N and P layers, waveguide barrier layers, etc. Many or all of these structures might include InP material systems, such as InGaAs, InGaP, InGaAlAs, InGaAlP, InAsGaP, etc.

Referring specifically to FIG. 9B, semiconductor wafer 30 is further modified by depositing multiple layers of metal/dielectric material to define insulated electrical interconnect layers 34 adjacent the upper surface. Electrical interconnect layers 34 allow electrical signaling (e.g. rf, microwave, ac, dc, etc.) to pass between the integrated devices (see below) and the exterior for bonding and signaling. Further, electrical interconnect layers 34 are insulated with interleaved dielectric layers to prevent shorting, etc. with lids that are subsequently sealed to the surface of the structure.

Referring specifically to FIG. 9C, photonic devices are fabricated into epi layers 32. In a preferred embodiment the photonic devices can include any or all of an emitter/detector 36, a modulator 38, a mux/demux device 40, and spot size converter 42. Also, emitter/detector 36, in the emitter form, preferably includes a laser, such as a distributed feedback (DFB) laser, a Fabry-Perot (FB) laser, a distributed Bragg reflector (DBR) laser, a tunable laser, a VCSEL (vertical cavity surface emitting laser), or any other type of semiconductor laser. Emitter/detector 36, in the detector form, preferably includes semiconductor diodes of the n-p, n-i-p, type or the like, which can be easily fabricated in the semiconductor/metal base. While the major components are listed above, the photonic devices can also include other components, such as modulators, detectors, mux, demux, waveguides, couplers, splitters, and spot size converters all in InP (in the preferred example). The modulator and at least some of the waveguide can be polymer based, e.g. a Mach-Zehnder structure, a ridge waveguide modulator, a slot modulator, or any modulator that can be conveniently fabricated in EO polymer based material.

Referring specifically to FIG. 9D, semiconductor wafer 30 is fabricated for optical fiber alignment/placement and to allow for mounting of a spherical lens and/or an isolator. In this embodiment this is accomplished by etching semiconductor wafer 30 (at the right hand side in the figures) to expose the end 44 of spot size converter 42 and to form depressions 46 and 48 and an elongated V-shaped trench 50 for receiving an optical fiber therein. Referring additionally to FIG. 9E, a spherical lens 52 is fixedly mounted in depression 46 so as to be optically aligned with spot size converter 42. Referring additionally to FIG. 9F, an optical isolator 54 is fixedly mounted in depression 48 so as to be optically aligned with spherical lens 52. Optical isolator 54 allows optical signals to be collimated and aligned for delivery to an optical fiber.

Referring additionally to FIG. 9G, an additional depression 56 is formed/etched adjacent the right hand end of semiconductor wafer 30 and an optical lens 58 is fixedly mounted therein in optical alignment with optical isolator 54. Optical lens 58 is designed to focus light to/from an optical fiber and allows optical signals to be more accurately aligned to an optical fiber. Referring additionally to FIG. 9H, one end of an optical fiber 60 is fixedly mounted in elongated V-shaped trench 50 so as to be optically aligned with optical lens 58. Thus, it can be seen that spherical lens 52, optical isolator 54, optical lens 58, and optical fiber 60 cooperate to form an optical input/output 61. It will be understood that any or all of spherical lens 52, optical isolator 54, and optical lens 58 may or may not be included in any specific structure, depending upon application and other engineering factors (e.g. materials used, alignment required, etc.).

Turning to FIG. 91, the structure of FIG. 9H is illustrated with metal contact pad 62 formed on the entire peripheral area (mating with edge 14a of lid 14), including spot size converter 42, so as to completely surround all of the photonic devices, including all of emitter/detector 36, modulator 38, mux/demux device 40, and all or nearly all of spot size converter 42. At this point contact pads 63 can also be formed to completely surround one or more components, in this example modulator 38. Metallization of contact areas (or area) 62 and 63 is preferably performed by using evaporation, ebeam, or sputtering of the metal onto the designated surface.

Referring additionally to FIG. 9K, a metalized lid 14′ is provided, which may be conductive or not according to the specific application (as metalized in any of FIGS. 6A-6C) is provided. Metalized lid 14′ is aligned and hermetically sealed to base 12 to encapsulate and hermetically seal modulator 38 (or any other component or components). A chamber 65 formed by the union of base 12 and lid 14′ is preferably filled with an inert gas (e.g. nitrogen, argon, etc.) which can be introduced by aligning and sealing lid 14′ in an atmosphere of the chosen inert gas. Thus, an embedded hermetic capsule, designated 11, is formed to include modulator 38. It will be understood that conductive layers in metalized conductive lid 14′ (or any other conductive layers devised) can be grid, planar, and different shapes/patterns. Also, conductive layers can be connected directly to ground, serve as a signal ground, or connected into a Faraday cage concept with electrical bias and electrical field gradients, generally as illustrated schematically in FIG. 8.

Referring additionally to FIG. 9L, a conductive lid 14 (as metalized in any of FIG. 6A-6C) is provided. Conductive lid 14 is aligned and hermetically sealed to base 12 to encapsulate and hermetically seal all of the sensitive semiconductor/polymer components. In this context, the term “sensitive” is defined to include any components formed of material that can be affected by the ambient (e.g. semiconductor and polymer components) while standard components of glass, etc, (e.g. spherical lens 52, isolator 54, optical lens 58, and optical fiber 60) are not sensitive and are generally not encapsulated. It will be understood that conductive layers in metalized conductive lid 14 (or any other conductive layers devised) can be grid, planar, and different shapes/patterns. Also, conductive layers can be connected directly to ground, serve as a signal ground, or connected into a Faraday cage concept with electrical bias and electrical field gradients, generally as illustrated schematically in FIG. 8.

The metalized sealing (of both lids 14′ and 14) can be accomplished, for example, via laser, seam, bonding, alloying, etc. A chamber 64 formed by the union of base 12 and lid 14 is preferably filled with an inert gas (e.g. nitrogen, argon, etc.) which can be introduced by aligning and sealing lid 14 in an atmosphere of the chosen inert gas. Thus, basic hermetic capsule, 10 is formed around all of the sensitive semiconductor/polymer components, as well as embedded hermetical capsule 11 formed to include modulator 38.

The combination of embedded hermetic capsule 11 and basic hermetic capsule 10 provide additional protection for sensitive devices and especially sensitive polymers from the environment. The combination of embedded hermetic capsule 11 and basic hermetic capsule 10 also compensate for any potential leaks in the basic hermetic capsule. Also, if a polymer modulator (for example) is protected (from the environment or electrical cross-talk, rf interference, even microwave electrical interference), by an embedded conductive lid, then another bigger hermetically sealed capsule provides stronger protection (or vice-versa). Embedded hermetic capsule 11 is designed not to affect the component covered, in this example modulator 38, but the component hermetically sealed could be laser 36 plus modulator 38, modulator 38 plus waveguide, mux/demux 40, and various combinations of components included in the circuitry. Also, as illustrated in FIG. 9M, more than one embedded hermetic capsule 11 may be included within basic hermetic capsule 10.

Referring again to FIG. 9J, the position of electrical interconnect layers 34 and the various optical components are illustrated in a top view of basic hermetic capsule 10 (even though they would be hidden by basic lid 14 and overlying material) to illustrate externally accessible electrical contacts or contact pads 66 and their connections to the electrical portions of emitter/detector 36 and modulator 38. The electrical lines formed in electrical interconnect layer 34 are buried in an insulating oxide or polymer layer or layers to avoid current leakage between adjacent lines and to avoid shorting to the metallization seals of both basic lid 14 and embedded lid 14′. Thus, it can be seen that embedded hermetic capsule 11 hermetically encapsulates one or more components and basic hermetic capsule 10 hermetically encapsulates all of the various semiconductor/polymer components while allowing external electrical and optical access. In this specific embodiment, the metallization in area 62, along with spot size converter 42 defines an optical output pathway for connection to an external device, such as an optical fiber. The electrical interconnect layers 34 and externally accessible electrical contacts or contact pads 66 are applicable to all embodiments and capsule designs.

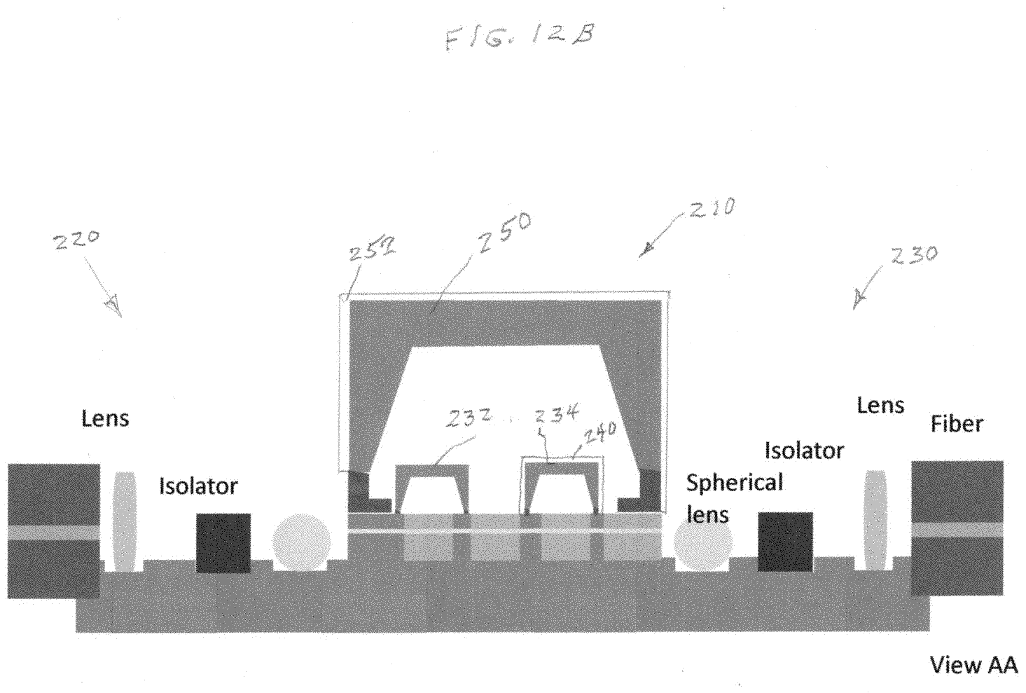

Turning to FIG. 10, an electrically conductive basic hermetic capsule 10 is illustrated with a conductive lid 25 similar to that illustrated in FIG. 5a and metallized as illustrated in FIG. 6A. Two embedded hermetic capsules 11 are incorporated in conductive basic hermetic capsule 10 and hermetically seal modulator 15 and mux/demux circuit 19. It will be understood that conductive coating 24 and conductive coating 25 can be connected directly to ground, or connected through leads in electrical interconnect layers 34 (see description above) to operate as a signal ground, or connected into a Faraday cage concept with electrical bias and electrical field gradients, generally as illustrated schematically in FIG. 8.

Turning to FIG. 11, an electrically conductive basic hermetic capsule 110 is illustrated with a conductive lid 125 and two embedded hermetic capsules 111 incorporated in conductive basic hermetic capsule 110 and hermetically sealing modulator 115 and mux/demux circuit 119. Conductive lid 125 includes three parallel spaced apart conductive coatings 130, 131 and 132. Another conductive coating 133 is deposited around the outer periphery of lid 125 and electrically connects all of the conductive coatings 130, 131 and 132 together as well as completing the suppression/protection of capsule 110 against rf interference, as well as any other electrical interference. It will be understood that conductive coatings 130-133 can be connected directly to ground, or connected through leads in electrical interconnect layers 34 (see description above) to operate as a signal ground, or connected into a Faraday cage concept with electrical bias and electrical field gradients, generally as illustrated schematically in FIG. 8.

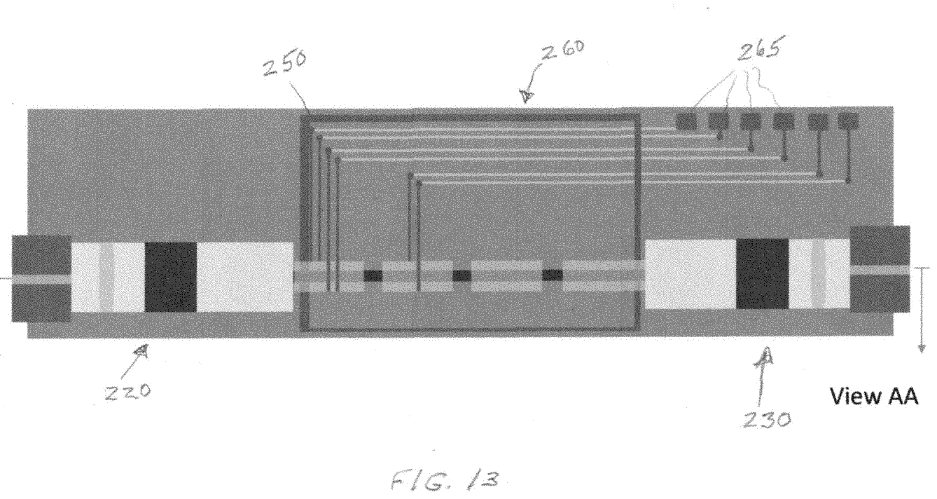

Turning to FIGS. 12A and 12B steps in the fabrication of another example of a conductive hermetic capsule 210 with multi-fibers/ports and embedded hermetic capsule{s} is illustrated, in accordance with the present invention. Referring specifically to FIG. 12A, conductive hermetic capsule 210 includes two optical input/output structures 220 and 230, each similar to optical input/output 61 described above in conjunction with FIG. 9H. Two embedded hermetic capsules 232 and 234 are bonded oversensitive components in the integrated laser/polymer circuitry. In addition, embedded capsule 234 has a conductive coating 240 deposited over the upper surface and around the entire outer periphery as suppression/protection of capsule embedded components against rf interference, as well as any other electrical interference. Referring specifically, to FIG. 12B, conductive hermetic capsule 210 is completed by bonding a basic conductive lid 250 over the sensitive components of hermetic capsule 210, including embedded hermetic lids 232 and 234. Basic conductive lid 250 includes a conductive coating 252 deposited over the upper surface and around the entire outer periphery as suppression/protection of capsule embedded components against rf interference, as well as any other electrical interference. Thus, in this specific example, the sensitive component in the embedded capsule formed by conductive embedded lid 234 has the extra suppression/protection of basic conductive lid 250.

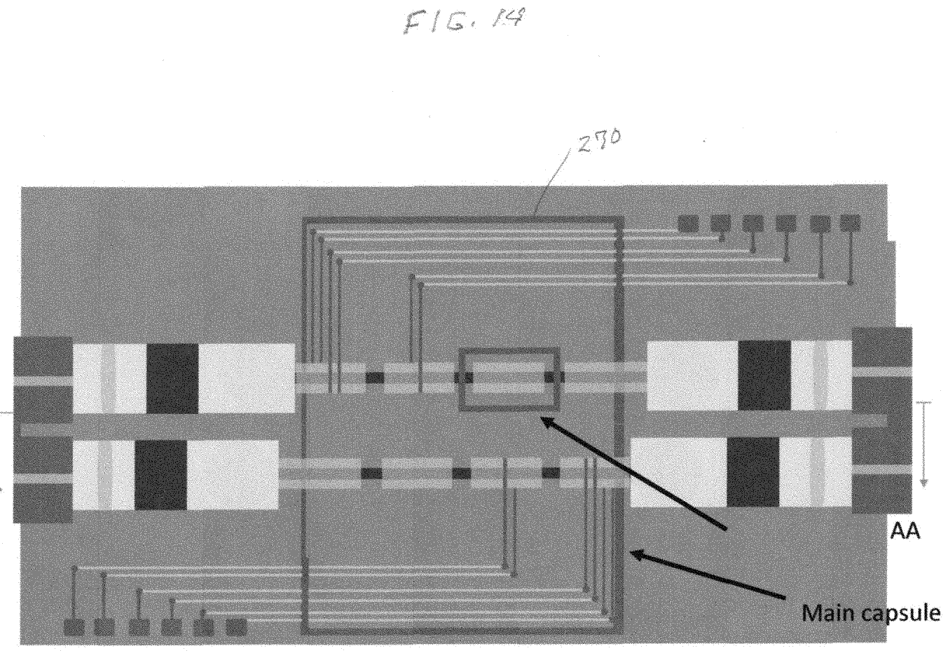

Turning to FIG. 13, a top plan view of the structure of FIG. 12B is illustrated to further show the external electrical connections, in accordance with the present invention. Electrical interconnect layers 260 electrically connect active sensitive circuits (e.g. lasers, detectors, modulators, etc.) to external contact pads 265. Thus, it can be seen that embedded hermetic capsules 232 and 234 hermetically encapsulate one or more sensitive components each and basic hermetic capsule 250 hermetically encapsulates all of the various sensitive semiconductor/polymer components while allowing external electrical and optical access. In this specific embodiment, the electrical interconnect layers 260 defines electrical input/output pathways for connection to external devices through contact pads 265. The electrical interconnect layers 260 and externally accessible electrical contacts or contact pads 265 are applicable to all embodiments and capsule designs described herein.

Turning to FIG. 14, a top plan view illustrating another example of a multi-fiber/port hermetic capsule is illustrated. In this specific example, two optic-electric structures similar to the structure of FIG. 12B/13 are illustrated and included in a single basic conductive lid 270. The view further illustrates the external electrical connections for multiple optical circuits embedded within a single basic lid, in accordance with the present invention.

In each of the above described basic and embedded hermetic capsules (including all structures/modifications), the semiconductor/metal basic or embedded lid is sealed to the semiconductor/metal base by metallization so as to form a chamber including one or more sensitive semiconductor/polymer components and hermetically seal the sensitive components from the ambient. In a preferred embodiment, the embedded lid and the basic lid(s) and base are fabricated from the same or similar material so that the coefficient of temperature expansion is not a problem. In the various modifications illustrated and described, some components are added or subtracted, as preferred in different applications, and the peripheral seal between basic lid and base may be moved to provide different sealing surfaces for different applications or metallizing procedures. In all instances of the structures/modifications, a basic hermetic capsule for hermetically sealing semiconductor/polymer material and especially for monolithic photonic integrated circuits (PICs) and optical components therein may include one or more embedded hermetic capsules. In all instances the conductive lid of an embedded hermetic capsule and the conductive lid of the basic hermetic capsule provide an optical pathway for optical fiber connections and high performance signaling (both electrical and optical). Further, both the base and the embedded conductive lids are fabricated on a wafer scale that is cost effective.

Thus, new and improved conductive lids for embedded and basic hermetic capsules for sealing multiple input, multiple output, and/or multiple input and output electrical and/or optical components on a common platform are illustrated and disclosed. In a preferred embodiment, the conductive embedded hermetic capsule contains and hermetically seals a laser and/or polymer modulator integrated on a common platform. The combination of conductive embedded and basic hermetic capsules with multiple inputs and/or outputs more efficiently seals sensitive components integrated on a common platform with electrical and optical coupling to the exterior. Also, fabrication of both the conductive embedded and conductive basic hermetic capsules is performed in a wafer scale solution that is cost effective.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A conductive hermetically sealed monolithic photonic integrated circuit (PIC) including optical components and multiple optical and electrical inputs/outputs comprising:
a semiconductor/metal base including sensitive semiconductor/polymer electrical and optical components with multiple optical and electrical inputs, multiple optical and electrical outputs, and/or multiple optical and electrical inputs and outputs;
an electrically conductive basic lid including at least two of metal, dielectric and semiconductor materials combined to form an electrically conductive protective circuit;
the conductive basic lid sealed to the semiconductor/metal base by metallization so as to form a chamber including the sensitive semiconductor/polymer electrical and optical components and hermetically sealing the chamber and the sensitive component from the ambient in a basic hermetic capsule and the electrically conductive protective circuit protecting the sensitive semiconductor/polymer electrical and optical components from external electrical interference.

2. The conductive hermetically sealed monolithic photonic integrated circuit (PIC) including optical components and multiple optical and electrical inputs/outputs as claimed in claim 1 wherein the semiconductor/metal base includes multiple layers of metal/dielectric material defining insulated electrical interconnect layers adjacent the upper surface extending from electrical components to externally accessible contact pads.

3. The conductive hermetically sealed monolithic photonic integrated circuit (PIC) including optical components and multiple optical and electrical inputs/outputs as claimed in claim 2 wherein the sensitive semiconductor/polymer electrical and optical components include at least two monolithic photonic integrated circuits with electrical components and the insulated electrical interconnect layers adjacent the upper surface extend from the electrical components to externally accessible contact pads.

4. The conductive hermetically sealed monolithic photonic integrated circuit (PIC) including optical components and multiple optical and electrical inputs/outputs as claimed in claim 1 wherein the electrically conductive protective circuit includes at least one electrically conductive protective coating extending one of through or across a surface or surfaces of the basic lid to, in cooperation with the semiconductor/metal base, completely surround the chamber.

5. The conductive hermetically sealed monolithic photonic integrated circuit (PIC) including optical components and multiple optical and electrical inputs/outputs as claimed in claim 4 wherein the at least one electrically conductive protective coating is one of connected directly to ground, or connected through leads in electrical interconnect layers to operate as a signal ground, or connected into a Faraday cage concept with electrical bias and electrical field gradients.

6. The conductive hermetically sealed monolithic photonic integrated circuit (PIC) including optical components and multiple optical and electrical inputs/outputs as claimed in claim 4 wherein the at least one electrically conductive protective coating includes two parallel spaced apart electrically conductive protective coatings.

7. The conductive hermetically sealed monolithic photonic integrated circuit (PIC) including optical components and multiple optical and electrical inputs/outputs as claimed in claim 6 wherein the two parallel spaced apart electrically conductive protective coatings further define one of active or inactive electronic components.

8. The conductive hermetically sealed monolithic photonic integrated circuit (PIC) including optical components and multiple optical and electrical inputs/outputs as claimed in claim 1 further including a semiconductor/metal embedded lid, the semiconductor/metal embedded lid sealed to the semiconductor/metal base by metallization so as to form an embedded chamber including at least one of the sensitive semiconductor/polymer electrical and optical components and hermetically sealing the embedded chamber and the at least one sensitive component from the ambient in an embedded hermetic capsule, and the conductive basic lid sealed to the semiconductor/metal base by metallization forming a basic chamber including the sensitive semiconductor/polymer electrical and optical components and the embedded hermetic capsule.

9. The conductive hermetically sealed monolithic photonic integrated circuit (PIC) including optical components and multiple optical and electrical inputs/outputs as claimed in claim 8 wherein the embedded lid includes at least two of metal, dielectric and semiconductor materials combined to form an embedded electrically conductive protective circuit.

10. The conductive hermetically sealed monolithic photonic integrated circuit (PIC) including optical components and multiple optical and electrical inputs/outputs as claimed in claim 9 wherein the embedded electrically conductive protective circuit includes at least one electrically conductive protective coating extending one of through or across a surface or surfaces of the embedded lid to, in cooperation with the semiconductor/metal base, completely surround the embedded chamber.

11. The conductive hermetically sealed monolithic photonic integrated circuit (PIC) including optical components and multiple optical and electrical inputs/outputs as claimed in claim 10 wherein the at least one electrically conductive protective coating of the embedded lid is one of connected directly to ground, or connected through leads in electrical interconnect layers to operate as a signal ground, or connected into a Faraday cage concept with electrical bias and electrical field gradients.

12. The conductive hermetically sealed monolithic photonic integrated circuit (PIC) including optical components and multiple optical and electrical inputs/outputs as claimed in claim 10 wherein the at least one electrically conductive protective coating of the embedded lid includes two parallel spaced apart electrically conductive protective coatings.

13. The conductive hermetically sealed monolithic photonic integrated circuit (PIC) including optical components and multiple optical and electrical inputs/outputs as claimed in claim 12 wherein the two parallel spaced apart electrically conductive protective coatings of the embedded lid further define one of active or inactive electronic components.

14. A conductive hermetically sealed monolithic photonic integrated circuit (PIC) including optical components and multiple optical and electrical inputs/outputs comprising:
a semiconductor/metal base including sensitive semiconductor/polymer electrical and optical components with multiple optical and electrical inputs, multiple optical and electrical outputs, and/or multiple optical and electrical inputs and outputs;
an embedded lid;
the embedded lid sealed to the semiconductor/metal base by metallization so as to form an embedded chamber including one or more of the sensitive semiconductor/polymer electrical and optical components and hermetically sealing the embedded chamber and the one or more sensitive components from the ambient in an embedded hermetic capsule and protecting the one or more sensitive semiconductor/polymer electrical and optical components from external ambient,
an electrically conductive basic lid including at least two of metal, dielectric and semiconductor materials combined to form an electrically conductive protective circuit; and
the electrically conductive basic lid sealed to the semiconductor/metal base by metallization so as to form a hermetically sealed basic chamber, the basic chamber surrounding and hermetically sealing the sensitive semiconductor/polymer electrical and optical components including the embedded hermetic capsule in a hermetically sealed basic hermetic capsule, the electrically conductive protective circuit protecting the sensitive semiconductor/polymer electrical and optical components from external electrical interference and the basic hermetic capsule including multiple optical pathways coupling multiple optical fibers to the optical components sealed within the chamber.

15. The conductive hermetically sealed monolithic photonic integrated circuit (PIC) including optical components and multiple optical and electrical inputs/outputs as claimed in claim 14 wherein the electrically conductive protective circuit of the basic lid includes at least one electrically conductive protective coating extending one of through or across a surface or surfaces of the basic lid to, in cooperation with the semiconductor/metal base, completely surround the chamber.

16. The conductive hermetically sealed monolithic photonic integrated circuit (PIC) including optical components and multiple optical and electrical inputs/outputs as claimed in claim 15 wherein the at least one electrically conductive protective coating of the basic lid is one of connected directly to ground, or connected through leads in electrical interconnect layers to operate as a signal ground, or connected into a Faraday cage concept with electrical bias and electrical field gradients.

17. The conductive hermetically sealed monolithic photonic integrated circuit (PIC) including optical components and multiple optical and electrical inputs/outputs as claimed in claim 15 wherein the at least one electrically conductive protective coating of the basic lid includes two parallel spaced apart electrically conductive protective coatings.

18. The conductive hermetically sealed monolithic photonic integrated circuit (PIC) including optical components and multiple optical and electrical inputs/outputs as claimed in claim 17 wherein the two parallel spaced apart electrically conductive protective coatings of the basic lid further define one of active or inactive electronic components.

19. The conductive hermetically sealed monolithic photonic integrated circuit (PIC) including optical components and multiple optical and electrical inputs/outputs as claimed in claim 14 wherein the embedded lid includes at least two of metal, dielectric and semiconductor materials combined to form an embedded electrically conductive protective circuit and the embedded electrically conductive protective circuit protecting the one or more of the sensitive semiconductor/polymer electrical and optical components from external electrical interference.

20. The conductive hermetically sealed monolithic photonic integrated circuit (PIC) including optical components and multiple optical and electrical inputs/outputs as claimed in claim 19 wherein the embedded electrically conductive protective circuit includes at least one electrically conductive protective coating extending one of through or across a surface or surfaces of the embedded lid to, in cooperation with the semiconductor/metal base, completely surround the embedded chamber.

21. The conductive hermetically sealed monolithic photonic integrated circuit (PIC) including optical components and multiple optical and electrical inputs/outputs as claimed in claim 20 wherein the at least one electrically conductive protective coating of the embedded lid is one of connected directly to ground, or connected through leads in electrical interconnect layers to operate as a signal ground, or connected into a Faraday cage concept with electrical bias and electrical field gradients.

22. The conductive hermetically sealed monolithic photonic integrated circuit (PIC) including optical components and multiple optical and electrical inputs/outputs as claimed in claim 20 wherein the at least one electrically conductive protective coating of the embedded lid includes two parallel spaced apart electrically conductive protective coatings.

23. The conductive hermetically sealed monolithic photonic integrated circuit (PIC) including optical components and multiple optical and electrical inputs/outputs as claimed in claim 22 wherein the two parallel spaced apart electrically conductive protective coatings of the embedded lid further define one of active or inactive electronic components.

24. A method of fabricating a conductive hermetically sealed monolithic photonic integrated circuit (PIC) including optical components and multiple optical and electrical inputs/outputs comprising the steps of:
providing a first semiconductor/metal wafer;
fabricating sensitive semiconductor/polymer electrical and optical components in the first semiconductor/metal wafer defining a semiconductor/metal base;
fabricating a semiconductor/metal embedded lid in a shell-like form providing edges defining a volume space within the edges;
hermetically sealing the edges of the semiconductor/metal embedded lid to the semiconductor/metal base by metallization so as to form a first chamber including at least one of the sensitive semiconductor/polymer electrical and optical components, the embedded lid and base defining an embedded hermetic capsule hermetically sealing the at least one sensitive semiconductor/polymer electrical and optical component from the ambient;
fabricating an electrically conductive basic lid including at least two of metal, dielectric and semiconductor materials and combining the at least two of metal, dielectric and semiconductor materials to form an electrically conductive protective circuit; and
hermetically sealing the edges of the electrically conductive basic lid to the semiconductor/metal base by metallization so as to form a hermetically sealed basic chamber, the basic chamber surrounding and hermetically sealing the sensitive semiconductor/polymer electrical and optical components including the embedded hermetic capsule in a hermetically sealed basic hermetic capsule, the electrically conductive protective circuit protecting the sensitive semiconductor/polymer electrical and optical components from external electrical interference and the basic hermetic capsule including multiple optical pathways coupling multiple optical fibers to the optical components sealed within the chamber.

25. The method as claimed in claim 24 wherein the step of fabricating an electrically conductive basic lid to form the electrically conductive protective circuit of the basic lid includes forming at least one electrically conductive protective coating extending one of through or across a surface or surfaces of the basic lid to, in cooperation with the semiconductor/metal base, completely surround the chamber.

26. The method as claimed in claim 25 wherein the step of forming the at least one electrically conductive protective coating of the basic lid includes one of connecting the coating directly to ground, or connecting the coating through leads in electrical interconnect layers to operate as a signal ground, or connecting the coating into a Faraday cage concept with electrical bias and electrical field gradients.

27. The method as claimed in claim 25 wherein thestep of forming the at least one electrically conductive protective coating of the basic lid includes the steps of forming two parallel spaced apart electrically conductive protective coatings.

28. The method as claimed in claim 17 wherein the step of forming two parallel spaced apart electrically conductive protective coatings of the basic lid further includes defining one of active or inactive electronic components in the two parallel spaced apart electrically conductive protective coatings.

29. The method as claimed in claim 24 wherein the step of fabricating the semiconductor/metal embedded lid includes combining at least two of metal, dielectric and semiconductor materials to form an embedded electrically conductive protective circuit and forming the embedded electrically conductive protective circuit to protect the one or more of the sensitive semiconductor/polymer electrical and optical components from external electrical interference.

30. The method as claimed in claim 29 wherein the step of forming the embedded electrically conductive protective circuit includes forming at least one electrically conductive protective coating extending one of through or across a surface or surfaces of the embedded lid to, in cooperation with the semiconductor/metal base, completely surround the embedded chamber.

31. The method as claimed in claim 30 wherein the step of forming the at least one electrically conductive protective coating of the embedded lid includes connecting the at least one electrically conductive protective coating one of directly to ground, or through leads in electrical interconnect layers to operate as a signal ground, or into a Faraday cage concept with electrical bias and electrical field gradients.

32. The method as claimed in claim 30 wherein the step of forming the at least one electrically conductive protective coating of the embedded lid includes forming two parallel spaced apart electrically conductive protective coatings.

33. The method as claimed in claim 22 wherein the step of forming the two parallel spaced apart electrically conductive protective coatings of the embedded lid further includes defining one of active or inactive electronic components in the two parallel spaced apart electrically conductive protective coatings.
